(19) United States
(12) Patent Application Publication
(10) Pub. No.: US 2013/0212533 A1
(43) Pub. Date: Aug. 15, 2013

(54) ELECTRONIC DEVICE AND METHOD FOR UNLOCKING TOUCH SCREENS

(71) Applicant: HSING-CHUN HSIEH, Shindian (TW)

(72) Inventor: HSING-CHUN HSIEH, Shindian (TW)

(73) Assignee: FIH (HONG KONG) LIMITED, Kowloon (HK)

(21) Appl. No.: 13/457,935

(22) Filed: Apr. 27, 2012

(30) Foreign Application Priority Data
Feb. 10, 2012 (TW) 101104465

(51) Int. Cl. G06F 3/033; G06F 3/048

(52) U.S. Cl. 715/835

(57) ABSTRACT

An electronic device and a method for unlocking touch screens randomly generates an unlocking sequence that includes one or more data combinations. Each of the data combinations includes one or more sets of coordinates on the touch screen. The nth data combination is selected from the unlocking sequence, and an unlocking icon is displayed on a particular location of the touch screen according to the selected data combination. After there is a touch on the unlocking icon during a predetermined time period, a next data combination in the unlocking sequence is selected to display the unlocking icon on another location of the touch screen, until all the data combinations have been selected. The touch screen is unlocked until the unlocking icon can be touched every time when displayed on different locations of the touch screen.

### BACKGROUND

1. Technical Field

Embodiments of the present disclosure relate to user interfaces that employ touch-sensitive displays, and more particularly to unlocking of touch screens on portable electronic devices.

2. Description of Related Art

Touch screens are popular for use as displays and user input devices on portable devices, such as mobile telephones and personal digital assistants (PDAs). One problem associated with using the touch screens on the portable devices is the unintentional activation or deactivation of functions due to unintentional contact with the touch screens. Thus, the touch screens on such devices, and/or applications running on such devices may be locked upon satisfaction of predefined lock conditions, such as upon ending an active call, or after a predetermined time of idleness has elapsed, or upon manual locking by a user.

Devices with the touch screens and/or applications running on such devices may be unlocked by any of several well-known unlocking procedures, such as pressing a predefined set of buttons (simultaneously or sequentially) or entering a code or password. These unlock procedures, however, have drawbacks. The button combinations may be hard to perform. Creating, memorizing, and recalling passwords, codes, and the like can be burdensome. These drawbacks may reduce the ease of use of the unlocking process and, as a consequence, the ease of use of the device in general.

### BRIEF DESCRIPTION OF THE DRAWINGS

FIG. 1 is a block diagram of one embodiment of an electronic device including an unlocking system.

FIG. 2 is a block diagram of one embodiment of function modules of the unlocking system in FIG. 1.

FIG. 3 illustrates a flowchart of one embodiment of a method for unlocking touch screens.

FIG. 4 illustrates examples of unlocking icons and corresponding IDs.

FIG. 5 illustrates an example of an unlocking sequence.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

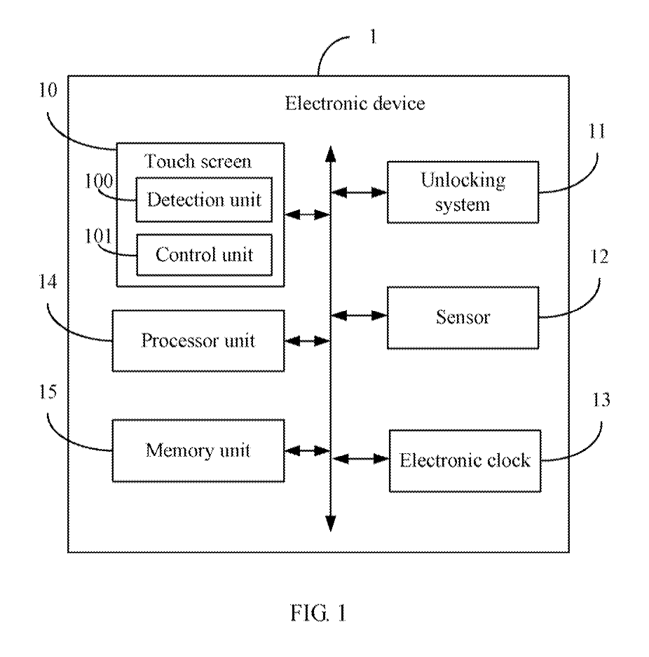

FIG. 1 is a block diagram of one embodiment of an electronic device 1 including an unlocking system 11. The electronic device 1 may be a smart phone, a computer, or a personal digital assistant (PDA), for example, which includes a touch screen 10. The touch screen 10 includes a detection unit 100 and a control unit 101. The detection unit 100 detects the presence and location information of a touch within a display area on the touch screen 10, and sends the location information of the touch to the control unit 101. The control unit 101 generates data as to the coordinates of the touch, and then sends the coordinates to the unlocking system 11.

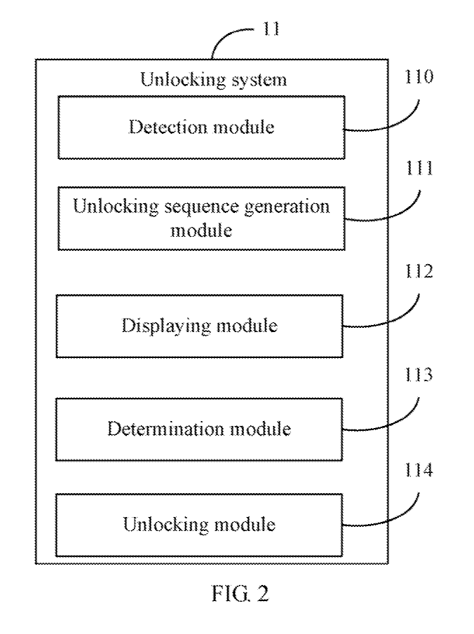

The unlocking system 11 includes a plurality of function modules (see FIG. 2 below), which include computerized code when executed to provide a method of unlocking the touch screen 10 by pressing one or more unlocking icons.

The electronic device 1 further includes a sensor 12. After being locked, the touch screen 10 may enter into a sleep mode after a predetermined time of inactivity has elapsed. The sensor 12 detects whether a waking condition of the touch screen 10 is triggered when the touch screen 10 is in the sleep mode. After the waking condition is triggered, the touch screen 10 enters into a working mode. The waking condition may be, that a predetermined physical button of the electronic device 1 is pressed, for example. The electronic device 1 may further include an electronic clock 13 for timing.

In addition, the electronic device 1 includes a processor unit 14. The processor unit 14 may include a processor, a microprocessor, an application-specific integrated circuit (ASIC), and a field programmable gate array (FPGA), for example. The processor unit 14 may execute the computerized code of the function modules of the unlocking system 11 to realize functions of the unlocking system 11.

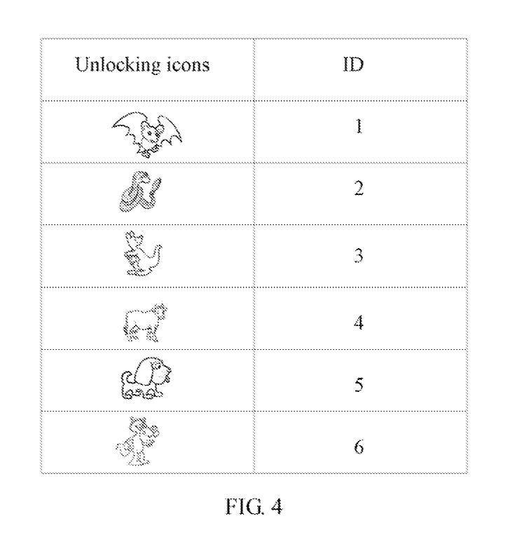

The electronic device 1 also includes a memory unit 15. The memory unit 15 may include any type(s) of non-transitory computer-readable storage medium, such as a hard disk drive, a compact disc, a digital video disc, or a tape drive . The memory unit 15 stores the computerized code of the function modules of the unlocking system 11. In addition, the memory unit 15 stores data as to one or more unlocking icons and an ID of each of the unlocking icons, as shown in FIG. 4.

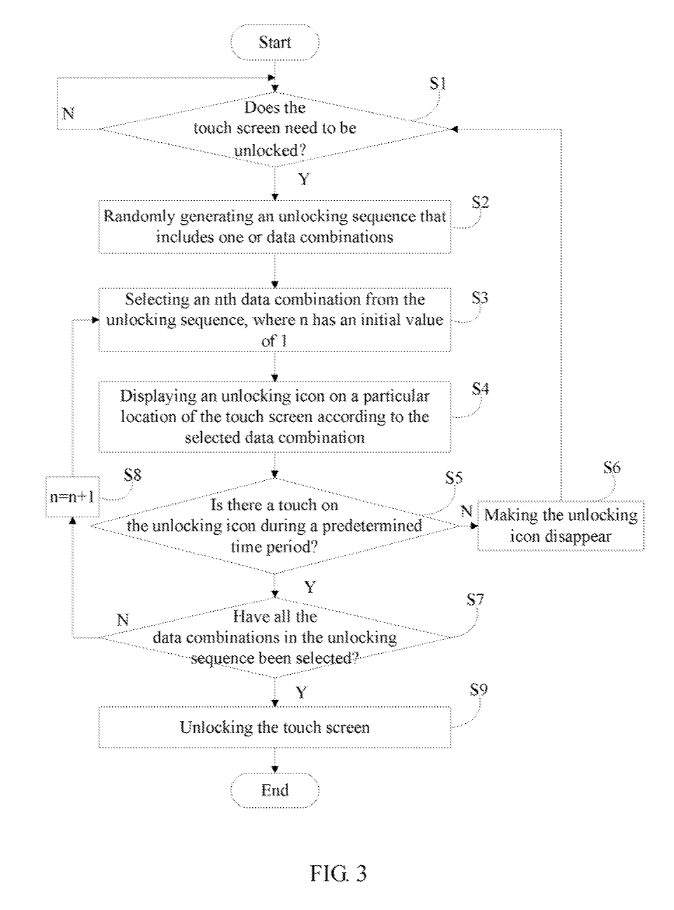

FIG. 2 is a block diagram of one embodiment of the function modules of the unlocking system 11. In one embodiment, the function modules may include a detection module 110, an unlocking sequence generation module 111, a displaying module 112, a determination module 113, and an unlocking module 114. The functions of the function modules 110-114 are illustrated in FIG. 3 and described below.

FIG. 3 illustrates a flowchart of one embodiment of a method for unlocking touch screens. Depending on the embodiment, additional steps may be added, others removed, and the ordering of the steps may be changed.

In step S1, the detection module 110 determines whether the touch screen 10 which is locked needs to be unlocked. In one embodiment, when the sensor 13 detects that the waking condition of the touch screen 10 is triggered, the sensor 13 may send a trigger signal to the detection module 110. The detection module 110 determines the touch screen 10 needs to be unlocked after receiving the trigger signal, and then, step S2 is implemented. Until such trigger signal is received, the detection module 110 determines that the touch screen 10 does not need to be unlocked now, and step Si is repeated.

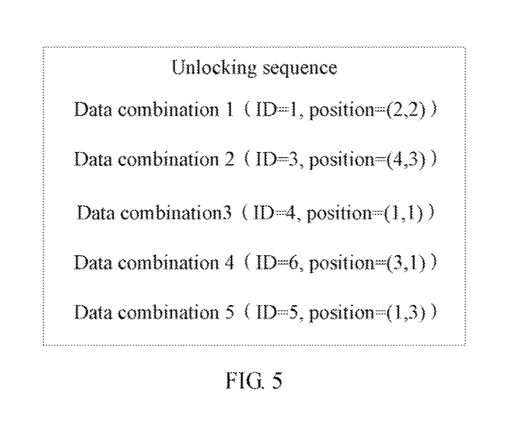

In step S2, the unlocking sequence generation module 111 randomly generates an unlocking sequence. The unlocking sequence includes one or more data combinations. Each of the data combinations includes an identification (ID) of an unlocking icon and a set of coordinates of the unlocking icon on the touch screen 10. In the present embodiment, the display area in the touch screen 10 is divided into P columns and Q rows (such as 9 columns and 9 rows). The coordinates indicate column and row numbers on the touch screen 10, for example, (1, 2) would indicate the first column, the second row, (3, 5) would indicate the third column, the fifth row, and (9, 4) would indicate the ninth column, the fourth row. FIG. 5 illustrates an example of the unlocking sequence. According to FIG. 5, the unlocking icon having the ID of 1 will be displayed at the second column and the second row of the touch screen 10, and the unlocking icon having the ID of 3 will be displayed at the fourth column and the third row. In one embodiment, when only a single unlocking icon is stored in the memory unit 15, the data combinations may only include one or more sets of coordinates for where the single unlocking icon will be displayed on the touch screen 10 each time.

In step S3, the displaying module 112 selects an nth data combination from the unlocking sequence, where n has an initial value of 1.

In step S4, the displaying module 112 displays the unlocking icon on a particular location of the touch screen 10 according to the ID and the coordinates in the selected data combination.

In step S5, the determination module 113 determines whether there is a touch on the unlocking icon during a predetermined time period. The touch may be made by a fingertip, a stylus, for example. In one embodiment, the first predetermined time period may be 1 minute, for example, and the period begins at the time of the unlocking icon being first displayed on the touch screen 10. For example, when the unlocking icon is displayed at 9:00, the predetermined time period may be from 9:00 to 9:01. As mentioned, the detection unit 100 of the touch screen 10 detects the presence and location information of any touch within the display area on the touch screen 10, and the control unit 101 of the touch screen 10 generates data as to the coordinates of the touch, and then sends the coordinates to the unlocking system 11. The determination module 113 determines whether the touch occurs on the unlocking icon according to the coordinates. Step S6 is implemented when the touch is other than on (i.e. another part of the screen is touched) the unlocking icon, and step S7 is implemented when the touch occurs exactly on the unlocking icon.

In step S6, the displaying module 112 makes the unlocking icon disappear from the touch screen 10.

In step S7, the determination module 113 determinates whether all the data combinations in the unlocking sequence have been selected. Step S8 is implemented when any data combination in the unlocking sequence has not been selected, and step S9 is implemented when all the data combinations in the unlocking sequence have been selected.

In step S8, the determination module 113 adds 1 to n, then step S3 is repeated.

In step S9, the unlocking module 113 unlocks the touch screen 10.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A method for unlocking touch screens being performed by execution of computerized codes by a processor of an electronic device which is installed with a touch screen, the method comprising:
(a) randomly generating an unlocking sequence that includes one or more data combinations, each of the data combinations comprising a set of coordinates on the touch screen;
(b) selecting an nth data combination from the unlocking sequence, and displaying an unlocking icon on a particular location of the touch screen according to the coordinates in the selected data combination;
(c) detecting a touch on the unlocking icon during a predetermined time period;
(d) determining whether all the data combinations in the unlocking sequence have been selected upon condition that there is a touch on the unlocking icon during the predetermined time period;
(e) repeating steps (b) through (d) until all data combinations in the unlocking sequence have been selected; and
(f) unlocking the touch screen.

2. The method according to claim 1, before step (a), the method further comprising:
determining whether the touch screen needs to be unlocked according to whether a waking condition of the touch screen is triggered.

3. The method according to claim 1, before step (a), the method further comprising:
storing one or more unlocking icons and an ID of each of the unlocking icons into a memory unit of the electronic device.

4. The method according to claim 3, wherein each of the data combinations further comprises an ID of an unlocking icon.

5. The method according to claim 1, after step (b) the method further comprising:
making the unlocking icon disappear from the touch screen upon condition that there is no touch on the unlocking icon during the predetermined time period.

6. The method according to claim 5, wherein the predetermined time period begins at the time of the unlocking icon being displayed on the touch screen.

7. A electronic device, comprising:
a non-transitory storage medium;
at least one processing unit; and
one or more modules that are stored in the non-transitory storage medium; and are executed by the at least one processing unit, the one or more modules comprising instructions to:
(a) randomly generate an unlocking sequence that includes one or more data combinations, each of the data combinations including a set of coordinates on the touch screen;
(b) select an nth data combination from the unlocking sequence, and display an unlocking icon on a particular location of the touch screen according to the coordinates in the selected data combination;
(c) detect a touch on the unlocking icon during a predetermined time period;
(d) determinate whether all the data combinations in the unlocking sequence have been selected upon condition that there is a touch on the unlocking icon during a predetermined time period;
(e) repeat steps (b) through (d) until all the data combinations in the unlocking sequence have not been selected; and
(f) unlock the touch screen.

8. The electronic device according to claim 7, before step (a) the one or more modules comprising instructions to:
determine whether the touch screen needs to be unlocked according to whether a waking condition of the touch screen is triggered.

9. The electronic device according to claim 8, before (a) the one or more modules further comprises instructions to:
store one or more unlocking icons and an ID of each of the unlocking icons into the non-transitory storage medium of the electronic device.

10. The electronic device according to claim 9, wherein each of the data combinations further includes an ID of an unlocking icon.

11. The electronic device according to claim 7, after (b) the one or more modules further comprises instructions to:
make the unlocking icon disappear from the touch screen upon condition that there is no touch on the unlocking icon during the predetermined time period.

12. The electronic device according to claim 11, wherein the predetermined time period begins at the time of the unlocking icon being displayed on the touch screen.

13. A non-transitory storage medium having stored thereon instructions that, when executed by a processor of an electronic device, causes the processor to perform a method for unlocking touch screens, wherein the method comprises:
(a) randomly generating an unlocking sequence that includes one or more data combinations, each of the data combinations comprising a set of coordinates on the touch screen;
(b) selecting an nth data combination from the unlocking sequence, and displaying an unlocking icon on a particular location of the touch screen according to the coordinates in the selected data combination;
(c) detecting a touch on the unlocking icon during a predetermined time period;
(d) determining whether all the data combinations in the unlocking sequence have been selected upon condition that there is a touch on the unlocking icon during the predetermined time period;
(e) repeating steps (b) through (d) until all data combinations in the unlocking sequence have been selected; and
(f) unlocking the touch screen.

14. The storage medium according to claim 13, before step (a), the method further comprising:
determining whether the touch screen needs to be unlocked according to whether a waking condition of the touch screen is triggered.

15. The storage medium according to claim 13, before step (a), the method further comprising:
storing one or more unlocking icons and an ID of each of the unlocking icons into a memory unit of the electronic device.

16. The storage medium according to claim 15, wherein each of the data combinations further includes an ID of an unlocking icon.

17. The storage medium according to claim 13, after step (b) the method further comprising:
making the unlocking icon disappear from the touch screen upon condition that there is no touch on the unlocking icon during the predetermined time period.

18. The storage medium according to claim 17, wherein the predetermined time period begins at the time of the unlocking icon being displayed on the touch screen.
